(19) United States
(12) Patent Application Publication
(10) Pub. No.: US 2026/0214726 A1
(43) Pub. Date: Jul. 23, 2026

(54) A PEST CONTROL SYSTEM AND A METHOD FOR BUILDING A NETWORK OF PEST CONTROL DEVICES

(71) Applicant: ANTICIMEX INNOVATION CENTER A/S, Helsinge (DK)

(72) Inventors: Peter HOHNEN, Tikøb (DK); Rasmus SKOU, Kokkedal (DK); Tomas OLSSON, Malmö (SE)

(73) Assignee: ANTICIMEX INNOVATION CENTER A/S, Helsinge (DK)

(21) Appl. No.: 19/141,514

(22) PCT Filed: Dec. 5, 2023
(86) PCT No.: PCT/EP2023/084326

§ 371 Date: Jun. 20, 2025

(30) Foreign Application Priority Data
Dec. 23, 2022 (DK) 2022 70651

(51) Int. Cl. H04W 76/11; A01M 23/20; A01M 31/00; H04W 52/02; H04W 84/18

(52) U.S. Cl. CPC H04W 76/11; A01M 23/20; A01M 31/002; H04W 52/0277; A01M 2200/01; H04W 84/18

(57) ABSTRACT

A pest control system comprising a gateway comprising a gateway memory, a wireless communications unit, and an external network communications unit. The system comprises a number of top tree nodes wherein each top tree node has the gateway as a sole parent, wherein each top tree node comprises a node memory and at least one wireless data communication unit, a number of tree nodes, wherein each tree node belongs to one sole tree-and has one sole parent.

Each tree node comprises a node memory and at least one data wireless communication unit, wherein each tree has a dedicated slot time during a repeat cycle to avoid interference between different trees.

### TECHNICAL FIELD

The present disclosure relates to a pest control system, a method for building a network of pest control devices, a data protocol for operating the network and a method of controlling the signal strength of a pest control network. More specifically, the disclosure relates to a pest control system, a method for building a network of pest control devices, a data protocol for operating the network and a method of controlling the signal strength of a pest control network as defined in the introductory parts of the independent claims.

### BACKGROUND ART

In most cities in the world, rodents, in particular rats, are a problem. Even though pest control has developed during the last decades, severe damages are still today caused by rodents. The damages are not only direct damages, e.g. food being eaten by rodents, but also indirect damages. An example of indirect damages is that restaurants where rats or other rodents have been found need to close down their business due to non-compliance with food safety regulations. Having reliable and efficient pest control is thus important from a wide range of aspects.

Insects may also cause problems. Problems associated with insects range from being a nuisance to actually causing tangible damages, for instance, by spreading diseases, ruining food or crops, destroying clothes, furniture, or even building materials. As a result property, buildings or other living spaces may become uninhabitable. To date, there has especially been a need for developing pest control for mosquitoes, cockroaches and flies, but the increased globalization leads to higher risk of global spreading of harmful insects.

New and improved methods for pest control are consequently being developed on an ongoing basis, a great deal of which is based on insecticides, pesticides, while other methods use actual traps, containing mechanical and/or electric means for pest control. The wording pests should be interpreted broadly to comprises e.g. rats, mice, ferrets, mink, and moles and rodents in general as well as insects such as e.g.

During the last few years, digitally connected pest control devices have become increasingly popular. For instance, the SMART solutions developed and marketed by Anticimex™ is one example well-known in the industry of pest control. By having traps and sensors connected to the Internet, continuous monitoring of these are made possible. This has the advantage that the need for manually checking the traps is reduced or in some cases completely removed. In addition, the traps may be provided with dual sensors, a first sensor for detecting that the trap has snapped, and a second sensor for detecting if a rodent is placed in the trap or not. With such set-up it is further made possible to distinguish between true positives, i.e. the trap has snapped and a rodent is present, and false positives, i.e. the trap has snapped, but no rodent is present. Still an advantage with the connected traps and sensors is that the use of biocides can be reduced or in some cases totally avoided.

Even though modern pest control offers sensors and traps enabling remote monitoring, there is still room for improvement. It is important that the network connected pest control devices are reliable so that animals or insects that are trapped can be removed. Especially is an animal is wounded in a trap it is for animal welfare reasons important that the system notifies the owner so that the situation can be quickly resolved. Manual intervention is, however, expensive. It is therefore especially important that the system function as expected. It is thereby a need for reliable pest control systems that report all detected animals or insects quickly.

Pest control devices are more and more commonly driven by batteries. It is for animal welfare reasons important that animals are not trapped in a trap that is powerless due to an empty battery. Exchanging batteries is expensive as it requires service personnel accessing each device. It is thereby desired that battery driven devices can run for a long time without the need for battery replacement. The type of network design used for the pest control network will affect how much information the devices will send in the network thereby affecting the battery life of battery driven devices. There is thus a need in the industry for improved network structures reducing the power consumption of the devices in the pest control system.

Lately mesh networks have been used for pest control systems. Mesh networks do, however, communicate a lot between the nodes in the network and thereby require the devices to send a lot of data. There is thus a need in the industry for improved network structures for pest control systems.

### SUMMARY

It is an object of the present disclosure to mitigate, alleviate or eliminate one or more of the above-identified deficiencies and disadvantages in the prior art and solve at least the above mentioned problem. According to a first aspect there is provided a pest control system comprising a gateway comprising a gateway memory, a wireless communication unit, and an external network communication unit. The pest control system comprises a number of top tree nodes wherein each top tree node has the gateway as a sole parent. Each top tree node comprises a node memory and at least one wireless data communication unit. The pest control system further comprises a number of tree nodes, wherein each tree node belongs to one sole tree and has one sole parent, wherein each tree node comprises a node memory and at least one data wireless communication unit. Each tree further has a dedicated slot time during a repeat cycle to avoid interference between different trees. According to some embodiments, each top tree node and each tree node is a trap device for an animal, a monitoring device, or both a trap and a monitoring device. According to some embodiments, the nodes and/or the gateway are/is comprises a battery as power source.

The wireless communication unit is used for the nodes of the pest control system to communicate while the external network communication unit is used to communicate with a backend server or a portable device for controlling and monitoring the pest control system. The gateway may, however, also be connected with a wire to an external network for communication with the backend server or a portable electronic device.

The network structure is utilizing both the benefits of a centralized network and a mesh network. Communication from the gateway to the top tree nodes is very quick as it is a direct communication. Devices not in range of the gateway communicate with the gateway by relaying data through one or several nodes. Different trees do not communicate with each other, which will save data traffic and reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

According to some embodiments, each top tree node and each tree node is arranged to communicate whether or not an animal is trapped and/or registered by the node so that a user can monitor the pest control around the clock or 24/7.

According to some embodiments, each top tree node and each tree node is a range extender. Every node will extend the network so as to make a tree of the network longer. A new trap device or monitor device thereby only has to be in range of any node in the pest control system making placement of devices easier.

According to some embodiments, each top tree node and each tree node comprises an address to its parent and a node database with addresses to all its direct children saved in the node memory. The nodes of the pest control system are thereby able to communicate with the closest nodes of the system, but not with other trees in the system. Communication in the system is thereby reduced which will reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

According to some embodiments, the nodes in the pest control system are arranged in as small trees as possible and as many trees as possible. If all devices are in range of the gateway every device will be a top tree node and alone in its tree. Only if a device is not in range of the gateway, a tree will be extended with tree nodes. Communication paths will thereby be reduced to a minimum which will reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

According to some embodiments, the gateway is arranged to communicate with a backend server so that the pest control system can be managed and monitored on distance by accessing the backend server, e.g. from an network connected computing device as a laptop or a smartphone.

According to some embodiments, all network traffic is encrypted to ensure integrity of the system and make the system harder to tamper with for anyone unauthorized. The system is thereby more reliable and less sensitive for disturbance from other equipment. This will reduce the risk for malfunction and thereby reduce the risk of an animal being trapped without the system reporting it. A safer system is also obtained. Problems associated with a third party intervening or eavesdropping are reduced.

According to a second aspect there a method is provided for building a network of pest control devices, the method comprising arranging a gateway, and a plurality of trap devices and monitoring devices in an area for pest control purposes, wherein the gateway and each trap device and monitoring device comprises a memory with a sub node database and wherein the gateway and each trap device and monitoring device are turned on; sending a pairing signal from the gateway at a rendezvous frequency; at each trap device or monitoring device that is receiving the pairing signal: assigning the trap device or monitoring device as top tree node in a tree, storing the assignments in the sub node database of the gateway, and storing the address of the gateway in the memory of the assigned trap device or monitoring device; at the gateway, broadcasting on the rendezvous frequency to the top tree nodes a network communication frequency; at the gateway, broadcasting on the network communication frequency to the top tree nodes individual dedicated slot times during a repeat cycle to avoid interference between them; and repeating until no additional trap device or monitoring device is responding and is added to the network: at each trap device or monitoring device with an empty sub node database, sending at the rendezvous frequency the pairing signal during the dedicated slot time of the tree; at each trap device or monitoring device that is receiving the pairing signal and that does not have a stored parent address stored: receiving on the rendezvous frequency information about frequency of the network communication frequency; receiving at the network communication frequency tree individual dedicated slot times during a repeat cycle; assigning the trap device or monitoring device as tree node in the tree of the top tree node; storing the network address of the trap device or monitoring device sending the pairing signal as parent address; assigning a node network address to the trap device or monitoring device; communicating on the network communication frequency the assigned node network address to the tree.

Accordingly a network of pest control devices is built with as small trees as possible and as many trees as possible. If all devices are in range of the gateway every device will be a top tree node and alone in its tree. Only if a device is not in range of the gateway, a tree will be extended with tree nodes. Communication paths will thereby be reduced to a minimum which will reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

According to some embodiments, the network address is indicative of which tree it belongs to and what tree level it is located at. If a node is not responding for some reason it is thereby easy to establish the implications for the network.

The data protocol sends the bare minimum that is required for the network protocol to function. The data amount communicated in the system is thereby reduced which will reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

According to some embodiments, the method comprises: at the gateway: detecting that one or a plurality of node in the network is not responding; adding the identity of any missing nodes to a lost node list; repeating for each node in the lost node list: iterating through the network level by level away from the top tree node level until the currently searched node is found: sending at the network communication frequency a pairing signal during the trees dedicated slot time; if receiving a response assigning the trap device or monitoring device a new network address and removing the trap device or monitoring device from the lost node list. A broken device or a device that for some reason does not access its parent node will thereby be handled by setting up the part of the network no longer connected again. Sub-nodes to the broken node may thereby be connected to a different tree instead if within range of any node in the network. This will produce a very resilient network that repairs itself automatically as much as is possible if problems arise. It will in turn reduce the risk of animals being trapped in a trap device that is not connected to the network reducing the risk for animals suffering undetected.

According to some embodiments, the method comprises setting the gateway in a battery mode in which the gateway enters a sleep mode when not required to communicate according to repeat cycle schedules. In case of power failure, the network will thereby keep working for a long time. This will produce an even more resilient network with reduced risk of malfunction.

According to a third aspect there is provided a method of controlling the signal strength of a pest control network according to the first aspect, comprising setting the signal strength of the gateway and all trap devices or monitoring devices of the pest control network to a first signal strength when arranging a new trap device or monitoring device at the location for pest control, wherein a new trap device or monitoring device is placed so as to receive a signal from the network; setting the signal strength of the gateway and all trap devices or monitoring devices of the pest control network to a second signal strength, stronger than the first signal strength, when building the network in accordance with the second aspect; setting the signal strength of the gateway and all trap devices or monitoring devices of the pest control network to a third signal strength, stronger than the second signal strength, when operating the pest control network for pest control. This will produce a more robust network with reduced risk of malfunction due to lost data packets. It will in turn reduce the risk of animals being trapped in a trap device that is not connected to the network reducing the risk for animals suffering undetected.

Effects and features of the second through third aspects are to a large extent analogous to those described above in connection with the first aspect. Embodiments mentioned in relation to the first aspect are largely compatible with the second through third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 illustrates a pest control system according to an embodiment of the present disclosure.

FIG. 2 shows a representation of a gateway of the pest control system shown in FIG. 1.

FIG. 3 shows a representation of a monitoring device of the pest control system shown in FIG. 1.

FIG. 4a shows a representation of a trap device of the pest control system shown in FIG. 1 in an open state.

FIG. 4b shows the trap device of FIG. 4a in an closed state with a trapped animal.

FIG. 5 is a block diagram illustrating a sub node data base of the gateway.

FIG. 6 is a block diagram illustrating a lost node list.

FIG. 7 is a flow chart disclosing a method according an embodiment according to the second aspect of the present disclosure.

FIG. 8 is a flow chart disclosing a method according an embodiment according to the third aspect of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

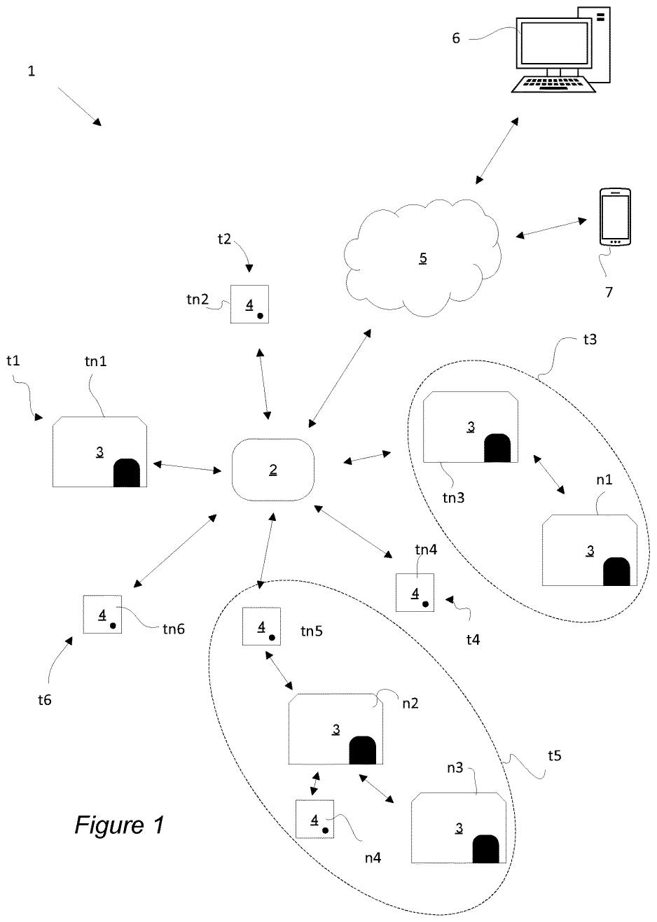

With reference to FIGS. 1, 2, 3 4a and 4b an embodiment of a pest control system 1 according to the first aspect of this disclosure is shown comprising a gateway 2 comprising a gateway memory 21, a wireless communication unit 22, and an external network communication unit 23. FIG. 1 shows a number of top tree nodes tn1-tn6 wherein each top tree node has the gateway 2 as a sole parent. Each top tree node tn1-tn6 comprises a node memory nm and at least one wireless data communication unit nc. FIG. 1 further shows a number of tree nodes n1,n2,n3,n4, wherein each tree node belongs to one sole tree t1-t6 and has one sole parent, wherein each tree node n1,n2,n3,n4 comprises a node memory nm and at least one data wireless communication unit nc; wherein each tree t1-t6 has a dedicated slot time during a repeat cycle to avoid interference between different trees.

As disclosed in FIG. 1 each top tree node tn1-tn6 and each tree node is a trap device 3 for an animal, a monitoring device 4, or both a trap and a monitoring device. Each top tree node tn1-tn6 and each tree node n1,n2,n3,n4 is arranged to communicate whether or not an animal is trapped and/or registered by the node. FIG. 3 discloses a monitoring device that has detected an insect 31, which is reported via the wireless data communication unit nc to the gateway via the pest control system. In FIG. 4a a rat has been detected as it moves towards the bait 42. The detected rat is reported via the wireless data communication unit nc to the gateway via the pest control system. In FIG. 4b, the trap door 43 is closed and the rat is, which is also reported via the wireless data communication unit nc to the gateway via the pest control system.

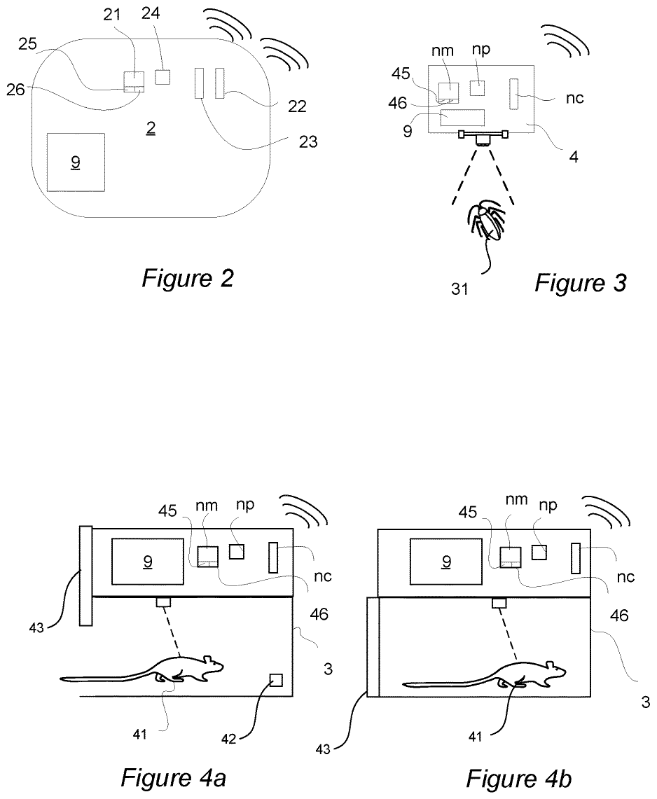

Each top tree node tn1-tn6 and each tree node n1, n2, n3, n4 is further a range extender and each top tree node tn1-tn6 and each tree node n1,n2,n3,n4 further comprises an address to its parent and a node database with addresses to all its direct children saved in the node memory. As disclosed in FIGS. 2, 3, 4a and 4b the nodes tn1-tn6,n1-n3 and the gateway 6 all comprises batteries 9 as power source or in the case of the gateway, as backup power source.

The nodes tn1-tn6, n1-n3 in the pest control system are arranged in as small trees t1-t7 as possible and as many trees t1-t6 as possible. In FIG. 1 all devices that are in range of the gateway is a top tree node tn1-tn6 and tn1, tn2, tn4, and tn6 are alone in their respective tree. The nodes n1-n4 are not in range of the gateway and are therefore arranged to communicate via the top tree nodes tn3 and tn5. The tree t5 contains three levels of nodes where the nodes n3 and n4 communicate with the node n2 as they are out of range from the top node tn5 in the tree t5. Thus the communication paths are reduced to a minimum which will reduce the energy consumption of the nodes increasing battery life time and reducing the risk for animals suffering in powerless traps will decrease. Intervals between battery exchange are also be longer reducing costs for managing the pest control system.

FIG. 1 further discloses how the gateway 2 is arranged to communicate with a backend server 6. A mobile computing device 7 can be used to access the backend server 6 so as to monitor and control the pest control system.

The gateway memory 21 further comprises an encryption module 25 and a decryption module 26 for enabling safe communication with the nodes tn1-tn6, n1-n4. In other examples, the encoder and/or decoder may form separate parts to the gateway memory 21. The gateway further comprises a control unit 24. The control unit 24 is configured to handle control signals, such as processor control signals. The control unit 24 comprises circuitry for executing computer instructions. The control unit 24 is further configured to execute the method steps of the present disclosure related to the gateway.

The control unit 24 is connected to the gateway memory 21, the external network communication unit 23 an the wireless data communication unit 22.

Each node tn1-tn6, n1-n4 also comprises a node memory nm. The node memory may be a non-volatile memory. The node memory nm stores the address to its parent node or gateway and addresses to all its children.

The node memory nm further comprises an encryption module 45 and a decryption module 46 for enabling safe communication with the gateway 2 or other nodes tn1-tn6, n1-n4. The node further comprise a control unit np. The control unit is connected to the node memory and the wireless communication module.

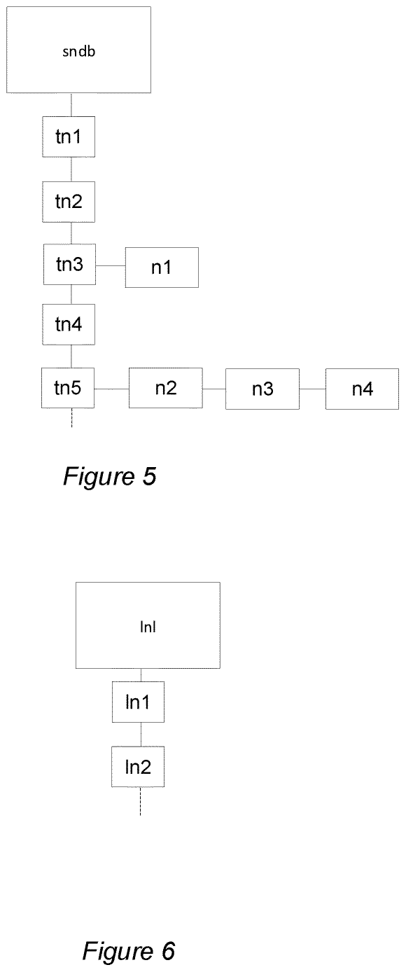

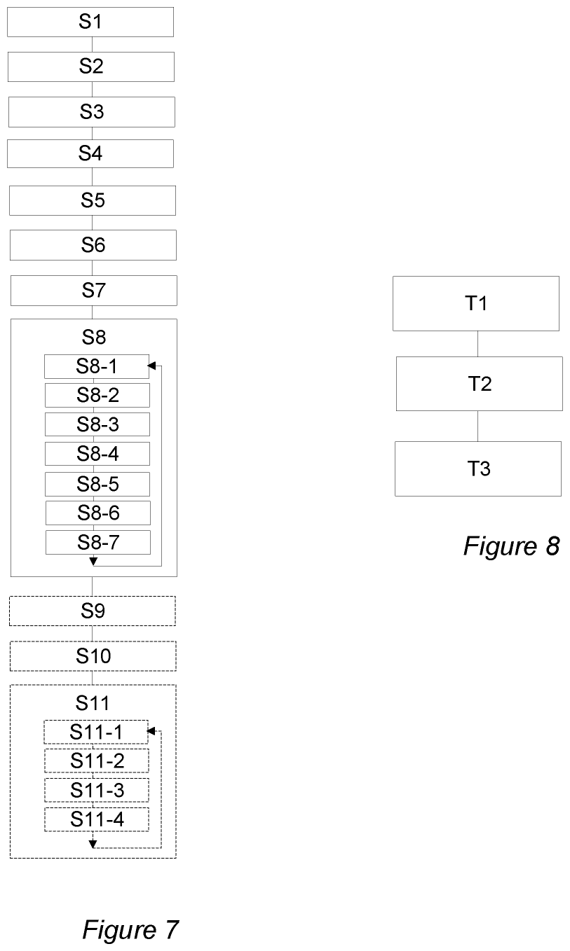

With reference to FIG. 7 the second aspect of this disclosure shows a method for building a network of pest control devices, the method comprising arranging S1 a gateway 6, and a plurality of trap devices 3 and monitoring devices 4 in an area for pest control purposes,. As disclosed in FIGS. 2, 3, 4a and 4b the gateway 2 and each trap device 3 and monitoring device 4 comprises a memory with a sub node database sndb. An example of a sub node database sndb of the devices disclosed in FIG. 1 is illustrated in FIG. 5. The gateway and each trap device 3 and monitoring device 4 are turned on and the gateway 2 is sending S2 a pairing signal at a rendezvous frequency. Each trap device 3 or monitoring device 4 that is receiving the pairing signal performs the following steps: assigning S3 the trap device 3 or monitoring device 4 as top tree node tn1-tn6 in a tree t1-t6, storing S4 the assignments in the sub node database of the gateway sndb, and storing S5 the address of the gateway in the memory nm of the assigned trap device 3 or monitoring device 4. The gateway then broadcasts S6 on the rendezvous frequency to the newly assigned top tree nodes tn1-tn6 a network communication frequency for further future communication. The gateway then broadcasts S7 on the network communication frequency to the top tree nodes tn1-tn6 individual dedicated slot times during a repeat cycle so that the trees t1-t6 will avoid interference between them when operating in the network. When top tree nodes tn1-tn6 are assigned the following steps are repeated S8 until no additional trap device 3 or monitoring device 4 is responding and is added to the network: at each trap device 3 or monitoring device 4 with an empty sub node database, sending S8-1 at the rendezvous frequency the pairing signal during the dedicated slot time of the tree t1-t6; at each trap device 3 or monitoring device 4 that is receiving the pairing signal and that does not have a stored parent address stored: receiving S8-2 on the rendezvous frequency information about frequency of the network communication frequency; receiving S8-3 at the network communication frequency tree individual dedicated slot times during a repeat cycle; assigning S8-4 the trap device 3 or monitoring device 4 as tree node n1-n3 in the tree t1-t6 of the top tree node tn1-tn6; storing S8-5 the network address of the trap device 3 or monitoring device 4 sending the pairing signal as parent address; assigning S8-6 a node network address to the trap device 3 or monitoring device 4; communicating S8-7 on the network communication frequency the assigned node network address to the tree t1-t6. The network address is indicative of which tree t1-t6 it belongs to and what tree level it is located at.

A network of pest control devices is thereby built with as small trees t1-t6 as possible and as many trees as possible. All devices in range of the gateway will be assigned a top tree node. Only if a device is not in range of the gateway, will a tree be extended with tree nodes n1-n4. Communication paths will thereby be reduced to a minimum which will reduce the energy consumption of the nodes. The battery of battery driven trap devices and monitoring devices will thereby last longer and the risk for animals suffering in powerless traps will decrease. Intervals between battery exchange will also be longer reducing costs for managing the pest control system.

With further reference to FIGS. 6 and 7 the method further comprises a method to handle lost nodes. At the gateway 2: detecting S9 that one or a plurality of nodes tn1-tn6,n1-n3 in the network is not responding; adding S10 the identity of any missing nodes In1, In2 to a lost node list Inl; repeating S11 for each node In1,In2 in the lost node list: iterating S11-1 through the network level by level away from the top tree node level until the currently searched node is found: sending S11-2 at the network communication frequency a pairing signal during the trees dedicated slot time; if receiving a response assigning S11-3 the trap device 3 or monitoring device 4 a new network address and removing S11-4 the trap device 3 or monitoring device 4 from the lost node list. A broken device or a device that for some reason does not access its parent node will thereby be handled by setting up the part of the network no longer connected again. Sub-nodes to the broken node may thereby be connected to a different tree instead if within range of any node in the network. This will produce a very resilient network that repairs itself automatically as much as is possible if problems arise. It will in turn reduce the risk of animals being trapped in a trap device that is not connected to the network reducing the risk for animals suffering undetected.

The method further comprises setting S12 the gateway in a battery mode in which the gateway enters a sleep mode when not required to communicate according to repeat cycle schedules.

With reference to FIG. 8, the third aspect of this disclosure shows a method of controlling the signal strength of a pest control network according to the first aspect, comprising setting T1 the first aspect the signal strength of the gateway 2 and all trap devices 3 or monitoring devices 4 of the pest control network to a first signal strength when arranging a new trap device 3 or monitoring device 4 at the location for pest control, wherein a new trap device 3 or monitoring device 4 is placed so as to receive a signal from the network; setting T2 the signal strength of the gateway 2 and all trap devices 3 or monitoring devices 4 of the pest control network to a second signal strength, stronger than the first signal strength, when building the network according to the second aspect; setting T3 the signal strength of the gateway 2 and all trap devices 3 or monitoring devices 4 of the pest control network to a third signal strength, stronger than the second signal strength, when operating the pest control network for pest control. This will produce an more robust network with reduced risk of malfunction due to lost data packets. As the system is set placed using reduced signal strength, the buildup of the network at a higher signal strength will have a strong signal for communicating. By then further increase the signal strength when operating the network for pest control, the risk of communication being lost due to bad reception is minimized or eliminated. This will in turn reduce the risk of animals being trapped in a trap device that is not connected to the network reducing the risk for animals suffering undetected.

The person skilled in the art realizes that the present disclosure is not limited to the preferred embodiments described above. The person skilled in the art further realizes that modifications and variations are possible within the scope of the appended claims. For example, a person skilled in the art understands that the network 5 may be the internet accessed via data access through a mobile telephone network. However, the connection to the network 5 could also be via hard wire at least partly. It is also understood that the nodes tn1-tn6, n1-n4 could be other types of pest control devices than the ones used as examples in the Figures. Additionally, variations to the disclosed embodiments can be understood and effected by the skilled person in practicing the claimed disclosure, from a study of the drawings, the disclosure, and the appended claims.

1. (canceled)

2. (canceled)

3. The method according to claim 8, further comprising:
at the gateway:
detecting that one or a plurality of node(s) in the network is not responding;
adding the identity of any missing nodes to a lost node list
repeating for each node in the lost node list:
iterating through the network level by level away from the top tree node level until the currently searched node is found:
sending at the network communication frequency a pairing signal during the trees dedicated slot time;
if receiving a response assigning the trap device or monitoring device a new network address and removing the trap device or monitoring device from the lost node list.

4. The method of claim 8, further comprising setting the gateway in a battery mode in which the gateway enters a sleep mode when not required to communicate according to repeat cycle schedules.

5. The method according to claim 8, wherein each top tree node and each tree node is a trap device for an animal, a monitoring device, or both a trap and a monitoring device.

6. The method according to claim 8, wherein each top tree node and each tree node is arranged to communicate whether or not an animal is trapped and/or registered by the node.

7. (canceled)

8. A method for building a network of pest control devices, the method comprising
arranging a gateway, and a plurality of trap devices and monitoring devices in an area for pest control purposes, wherein the gateway and each trap device and monitoring device comprises a memory with a sub node database and wherein the gateway and each trap device and monitoring device are turned on;
sending a pairing signal from the gateway at a rendezvous frequency;
for each trap device or monitoring device that is receiving the pairing signal:
assigning the trap device or monitoring device as top tree node in a tree;
storing the assignments in the sub node database of the gateway; and
storing the address of the gateway in the memory of the assigned trap device or monitoring device;
at the gateway, broadcasting on the rendezvous frequency to the top tree nodes a network communication frequency; and
at the gateway, broadcasting on the network communication frequency to the top tree nodes, individual dedicated slot times during a repeat cycle, wherein the individual dedicated slot times during a repeat cycle are used to avoid interference between different trees; and
repeating until no additional trap device or monitoring device is responding and is added to the network:
at each trap device or monitoring device with an empty sub node database, sending at the rendezvous frequency the pairing signal during the dedicated slot time of the tree, wherein each top tree node and each tree node comprises an address to its parent and a sub node database with addresses to all its direct children saved in the node memory;
at each trap device or monitoring device that is receiving the pairing signal and that does not have a stored parent address stored:
receiving on the rendezvous frequency information about frequency of the network communication frequency;
receiving at the network communication frequency tree individual dedicated slot times during a repeat cycle;
assigning the trap device or monitoring device as tree node in the tree of the top tree node;
storing the network address of the trap device or monitoring device sending the pairing signal as parent address;
assigning a node network address to the trap device or monitoring device;
communicating on the network communication frequency the assigned node network address to the tree, wherein the network address is indicative of which tree it belongs to and what tree level it is located at;
wherein each top tree node and each tree node is a range extender and wherein one or a plurality of any of the top tree nodes or the tree nodes comprise a battery as power source.

9. The method according to claim 8, wherein the nodes in the pest control system are arranged in as small trees as possible and as many trees as possible.

10. The method according to claim 8, wherein the gateway is arranged to communicate with a backend server.

11. The method according to claim 8, wherein the gateway comprises a battery as power source.

12. The method according to claim 8, wherein all network traffic is encrypted.

13. A method of controlling a signal strength of a pest control network set up according to a method comprising:
arranging a gateway, and a plurality of trap devices and monitoring devices in an area for pest control purposes, wherein the gateway and each trap device and monitoring device comprises a memory with a sub node database and wherein the gateway and each trap device and monitoring device are turned on;
sending a pairing signal from the gateway at a rendezvous frequency;
for each trap device or monitoring device that is receiving the pairing signal:
assigning the trap device or monitoring device as top tree node in a tree;
storing the assignments in the sub node database of the gateway; and
storing the address of the gateway in the memory of the assigned trap device or monitoring device;
at the gateway, broadcasting on the rendezvous frequency to the top tree nodes a network communication frequency; and
at the gateway, broadcasting on the network communication frequency to the top tree nodes, individual dedicated slot times during a repeat cycle, wherein the individual dedicated slot times during a repeat cycle are used to avoid interference between different trees; and
repeating until no additional trap device or monitoring device is responding and is added to the network:
at each trap device or monitoring device with an empty sub node database, sending at the rendezvous frequency the pairing signal during the dedicated slot time of the tree, wherein each top tree node and each tree node comprises an address to its parent and a sub node database with addresses to all its direct children saved in the node memory;
at each trap device or monitoring device that is receiving the pairing signal and that does not have a stored parent address stored:
receiving on the rendezvous frequency information about frequency of the network communication frequency;
receiving at the network communication frequency tree individual dedicated slot times during a repeat cycle;
assigning the trap device or monitoring device as tree node in the tree of the top tree node;
storing the network address of the trap device or monitoring device sending the pairing signal as parent address;
assigning a node network address to the trap device or monitoring device;
communicating on the network communication frequency the assigned node network address to the tree, wherein the network address is indicative of which tree it belongs to and what tree level it is located at;
wherein each top tree node and each tree node is a range extender and wherein one or a plurality of any of the top tree nodes or the tree nodes comprise a battery as power source;
the method of controlling a signal strength of the pest control network comprising:
setting the signal strength of the gateway and all trap devices or monitoring devices of the pest control network to a first signal strength when arranging a new trap device or monitoring device at the location for pest control, wherein a new trap device or monitoring device is placed so as to receive a signal from the network;
setting the signal strength of the gateway and all trap devices or monitoring devices of the pest control network to a second signal strength, stronger than the first signal strength, when building the network; and
setting the signal strength of the gateway and all trap devices or monitoring devices of the pest control network to a third signal strength, stronger than the second signal strength, when operating the pest control network for pest control.
